(19) United States
(12) Patent Application Publication
(10) Pub. No.: US 2013/0136996 A1
(43) Pub. Date: May 30, 2013

(54) ASYMMETRIC HYBRID LITHIUM SECONDARY BATTERY HAVING BUNDLE TYPE SILICON NANO-ROD

(71) Applicant: Korea Institute of Science and Technology, Seoul (KR)

(72) Inventors: Joong Kee LEE, Seoul (KR); Byung Won CHO, Seoul (KR); Hwa Young LEE, Seoul (KR); Byoung Sung AHN, Seoul (KR); Joo Man WOO, Seoul (KR); Sang Ok KIM, Seoul (KR); Ji Hun PARK, Gyeongsangnam-do (KR); Jung Sub KIM, Gyeongsangnam-do (KR); Nguyen Si HIEU, Seoul (KR)

(73) Assignee: KOREA INSTITUTE OF SCIENCE AND TECHNOLOGY, Seoul (KR)

(21) Appl. No.: 13/681,560

(22) Filed: Nov. 20, 2012

(30) Foreign Application Priority Data
Nov. 24, 2011 (KR) 10-2011-0123739

(51) Int. Cl. H01M 4/38; H01M 4/04; H01M 4/583

(52) U.S. Cl. CPC H01M 4/386; H01M 4/583; H01M 4/0428; H01M 4/049; H01M 4/04; B82Y 30/00
USPC 429/231.8; 977/762

(57) ABSTRACT

Disclosed are a metallic nano-structure material in which an energy storage capacity based on electrochemical reaction with lithium is improved by 10 times or more compared to a conventional graphite material and power characteristics are excellent, an electrode composed of the metallic nano-structure material, and a lithium ion asymmetric secondary battery including the electrode as an anode. When using the electrode for the lithium ion asymmetric secondary battery, energy larger than with the graphite material can be stored with very thin thickness due to the high-capacity feature of the metallic material and the high-power feature can be achieved by the nano structure, such that energy density can be innovatively improved in the same weight condition when compared to a conventional lithium ion capacitor, and the lithium ion asymmetric secondary battery including the electrode can be used for renewable energy storage, ubiquitous power supply, heavy machinery, vehicle power source, etc.

### CROSS-REFERENCE TO RELATED APPLICATION

This application claims under 35 U.S.C. §119(a) the benefit of Korean Patent Application No. 10-2011-0123739 filed on Nov. 24, 2011, the entire contents of which are incorporated herein by reference.

### BACKGROUND

(a) Technical Field

The present invention relates to an electrode material for an asymmetric hybrid lithium ion battery or a lithium ion capacitor which includes an organic solvent electrolyte solution of lithium salt, and a lithium ion asymmetric secondary battery.

(b) Background Art

Recently, as techniques of the electrochemical energy storage device field, such as lithium secondary batteries, capacitors, etc., have been rapidly developed, application fields are expanding from small-size electronic devices like notebooks, portable phones, etc., to mid-sized and large products such as electric vehicles, power storage, etc. In particular, due to unbalanced energy supply and environment problems, energy storage devices for the transport field, such as hybrid vehicles, electric vehicles, and so forth are now actively developed. A power source for a transport field, which is newly appealing as a main application field, essentially needs high energy density, high power, high stability, and long lifespan.

A lithium secondary battery refers to a battery which stores and radiates energy based on electrochemical oxidation-reduction between cathode and anode activated materials, and a capacitor refers to an element which operates based on physical adsorption and desorption of ions on the activated material surface. As such, the lithium ion secondary battery and the capacitor operate according to different principles, such that characteristics shown by them are also different from each other and in the current technical level, the capacitor has the excellent power property, but low capacity, whereas the lithium secondary battery has poor power property and cycle lifespan, but high capacity. Thus, recent research and development have been oriented to high capacity of the capacitor and high power of the lithium secondary battery, and a new energy storage device having such characteristics is expected to satisfy a required level of a power source for the transport field.

As one of a power source device which may have high power together with high energy density, a lithium ion capacitor has recently been studied with much attention. This device has energy density which is higher than a conventional electric double layer capacitor (EDLC) by about four times and has power density which is higher than a conventional lithium secondary battery by about two times. The lithium ion capacitor is manufactured by combining a capacitor electrode and a lithium secondary battery electrode, and based on this structure, during charge/discharge, one electrode of them experiences physical reaction and the other electrode experiences electrochemical reaction. That is, two types of electrodes operating based on different reactions are hybridized, thereby maintaining power characteristics and increasing energy density.

Such a lithium ion capacitor generally uses a polarizable electrode in a cathode and a non-polarizable electrode in an anode in system configuration, in which lithium ions are caused to contact metallic lithium of the adsorbable and desorbable anode to reduce an anode potential corresponding to lithium doping, thus increasing an internal voltage and largely improving energy density. Herein, a hole perforating surfaces of anode and cathode electric collectors of a cell is formed, and lithium ions move through this hole, such that metallic lithium and the anode are short-circuited. [Korean Patent Application Publication No. 10-2008-0007262 and Japanese Patent Application No. JP-P-2005-00329455 filed by Taguchi Hiromoto, et al., and Korean Patent Application Publication No. 10-2008-0072712 and Japanese Patent Application No. JP-P-2005-00355409 filed by Matshi Kohey, et al.]

A conventional technique related to a lithium ion capacitor element has proposed the use of graphite and a carbide which are previously doped with activated carbon for a cathode and lithium for an anode [J. of Power Sources, 177 (2008)643-651], the use of a metallic oxide as a cathode and activated carbon or a metallic oxide as an anode [Korean Patent Application Publication Nos. 10-2011-0002211, 10-2008-0029479, 10-2009-0095805, Journal of Power Sources. 196 (2011) 4136.4142], and so forth. In addition, a liquid silicon precursor of two types of (CH₃)₃SiO{CH₃(H)SiO}mSi(CH₃)₃ (m.20) and {CH₃(CH═CH₂)SiO}ᵥ (n=3.7) is thermally treated in argon of 1300° C. and then is dipped in urethane form chips to synthesize a-SiCO and use it as a lithium ion capacitor electrode [Journal of Power Sources 191 (2009) 623.627].

Thus, the present inventors have developed an asymmetric hybrid anode which maintains high power and shows super-high capacity per unit weight by applying a porous semiconductor material of a column structure capable of high-speed delivery of lithium ions, and a new asymmetric hybrid lithium ion battery including the asymmetric hybrid anode.

### SUMMARY OF THE DISCLOSURE

Accordingly, the present invention has been made to solve the foregoing problem, and provides a lithium ion asymmetric secondary battery electrode using an electrode material which may be alloyed with lithium, in which by changing a molding structure of a silicon material which has poor cycle and rate capability due to volume change of 3 times or more occurring in alloy reaction with lithium, in spite of the excellent volume aspect, energy storage capacity is innovatively improved and power characteristics are improved.

The other objects and advantages of the present invention will become more apparent by the detailed description, appended claims, and drawings.

According to an aspect of the present invention, there is provided an asymmetric hybrid lithium ion battery comprising a cathode which is an activated carbon and an anode which is silicon alloyed with lithium.

According to an exemplary embodiment of the present invention, bundle type silicon nano-rod alloyed with lithium having a column structure or phosphorus-doped silicon alloyed with lithium is used for an anode.

### BRIEF DESCRIPTION OF THE DRAWINGS

The above and other features of the present invention will now be described in detail with reference to an exemplary embodiment thereof illustrated the accompanying drawings which are given hereinbelow by way of illustration only, and thus are not limitative of the present invention, and wherein:

FIG. 1 is a structure conceptual diagram of a lithium ion capacitor having a bundle type silicon nano-rod electrode according to the present invention, in which the manufactured porous silicon electrode material has a large interface, thus having a high lithium on transfer speed and in the manufactured nano-rod space, stress affecting an electrode material due to volume expansion occurring in alloy reaction with lithium ions is relaxed, thus providing an electrode material having superior stability;

FIG. 2 shows an electron microscope surface shape of a bundle type silicon nano-rod electrode manufactured by Manufacturing Example 3;

FIG. 3 is a schematic diagram showing a process of manufacturing a lithium ion electrode cell according to Manufacturing Example 1, Manufacturing Example 2, and Manufacturing Example 3;

FIG. 4 is a graph showing performance of a bundle type silicon nano-rod capacitor relative to a thickness of a porous silicon electrode; and

FIG. 5 is a graph for comparing performance of bundle type silicon nano-rod with an phosphorus-doped bundle type silicon nano-rod electrode.

### DETAILED DESCRIPTION

Hereinafter, the present invention will be described in detail with reference to the accompanying drawings to allow those of ordinary skill in the art to easily carry out the present invention.

According to an aspect of the present invention, the present invention provides an asymmetric hybrid lithium ion battery including a cathode formed of activated carbon and an anode formed of silicon alloyed with lithium.

According to an exemplary embodiment of the present invention, porous silicon or phosphorus-doped silicon having a column structure is used for an anode.

According an exemplary embodiment of the present invention, the silicon having the column structure has an equivalent diameter of about 50-100 nm (and a height thereof is about 500-5000 nm, and more preferably, 2500-3000 nm.

According to an exemplary embodiment of the present invention, the phosphorus-doped silicon is doped with phosphorus using electron cyclotron resonance and chemical vapor deposition.

According to an exemplary embodiment of the present invention, the amount of doped phosphorus in the phosphorus-doped silicon is about 0.1-10 wt %, more preferably, about 0.5-3 wt %, relative to a total doped-silicon electrode.

According to an exemplary embodiment of the present invention, the bundle type silicon nano-rod forms porosity via electroless etching.

With reference to the following embodiment and comparison examples, the present invention will be described in detail. However, the following embodiment is merely illustrative, and the scope of the present invention is not limited thereto.

### (1) Manufacturing Example 1

### Manufacturing of Cathode and Anode

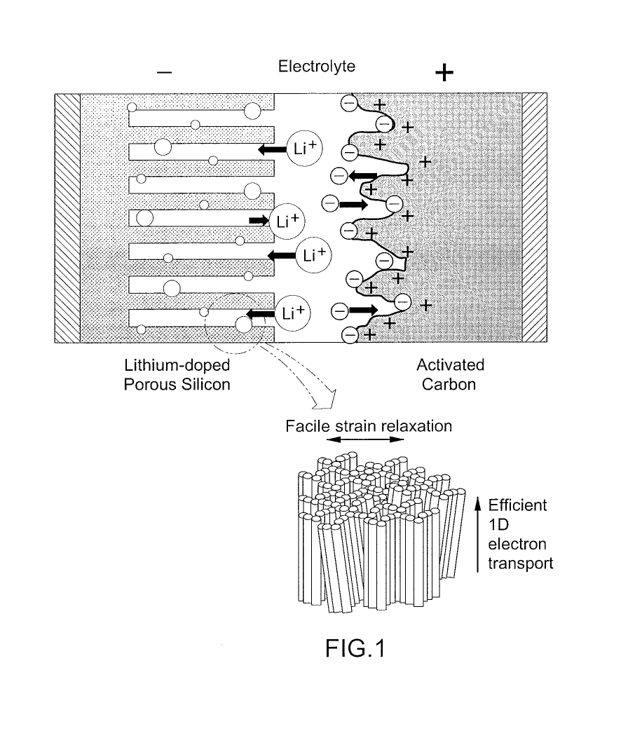

In this manufacturing example, an activated carbon electrode used in an asymmetric secondary battery is used as a cathode and a silicon thin film electrode much studied as an anode activated material of a lithium secondary battery is used as an anode, thus manufacturing a lithium ion asymmetric secondary battery (FIG. 1).

First, to manufacture a cathode, an activated carbon (YP-50F, Kuraray Chemical) is mixed with Denka Black-100, which is a conducting agent, and Polyvinylidene Fluoride (PVdF), which is a coupling agent, at a weight ratio of 85:5:10, after which they are stirred uniformly at 5000 rpm using NMP as a dispersion medium to manufacture a slurry which is then coated onto an Al current collector, and then the cathode is dried for 1 hour at 80° C. The dried cathode is cut into a predetermined size of 2×2 cm² and rolled to a thickness of 50 μm at 120° C. by using a rolling press.

Next, a silicon thin film electrode used as an anode is manufactured using electron cyclotron resonance-chemical vapor deposition. For a deposition substrate, a Cu current collector (˜20 μm) used in manufacturing a lithium secondary battery anode is used. The Cu current collector is cut into a size of 10×10 cm² and an organic material existing on the surface is removed by cleaning the Cu current collector with acetone and ethanol, after which the Cu current collector is dried for 1 hour at 80° C. The dried Cu current collector is placed on a chamber of a deposition equipment, and a high-vacuum state below 1×10-5 Torr is maintained and a substrate temperature is adjusted to 200° C. An Ar gas having a flow rate of 30 sccm flows into the chamber, and while maintaining a processing pressure at 15 mTorr, plasma is generated with microwave power of 700 W. The reflected power is adjusted within 5 W, and a silane (SiH) gas of 20 sccm is inserted, thus manufacturing a silicon thin film electrode.

In this state, by adjusting a deposition time, the thickness of a silicon thin film is made to 500 nm, 1500 nm, and 3000 nm. The manufactured anode and cathode are dried in a vacuum oven for 4 hours at 80° C. to completely remove moisture.

### (2) Manufacturing Example 2

### Manufacturing of Phosphorus-Doped Silicon Thin Film Anode

The same cathode as used in Manufacturing Example 1 is used, and for an anode, a phosphorus-doped silicon thin film electrode is manufactured.

When a deposition process is performed to dope phosphorus, except for simultaneously injection of a silane gas and a phosphine gas (PH3), the same method as used in manufacturing of the silicon thin film electrode in Manufacturing Example 1 is used. The silane gas and the phosphine gas are injected at 20 sccm and 0.2 sccm, respectively, that is, at a flow rate ratio of 100:1. By adjusting a deposition time, the thickness of a phosphorus-doped silicon thin film is 3000 nm. The amount of phosphorus existing in the manufactured silicon is about 1% as a weight rate. Next, like in Manufacturing Example 1, the manufactured anode is dried in a vacuum oven at 80° C. for 4 hours.

### (3) Manufacturing Example 3

### Manufacturing of Bundle Type Silicon Nano-Rod Anode after Electroless Etching

The same cathode as used in Manufacturing Example 1 is used, and for an anode, electroless etching is applied to the silicon thin film electrode manufactured in Manufacturing Example 1, thus manufacturing a porous silicon structure electrode.

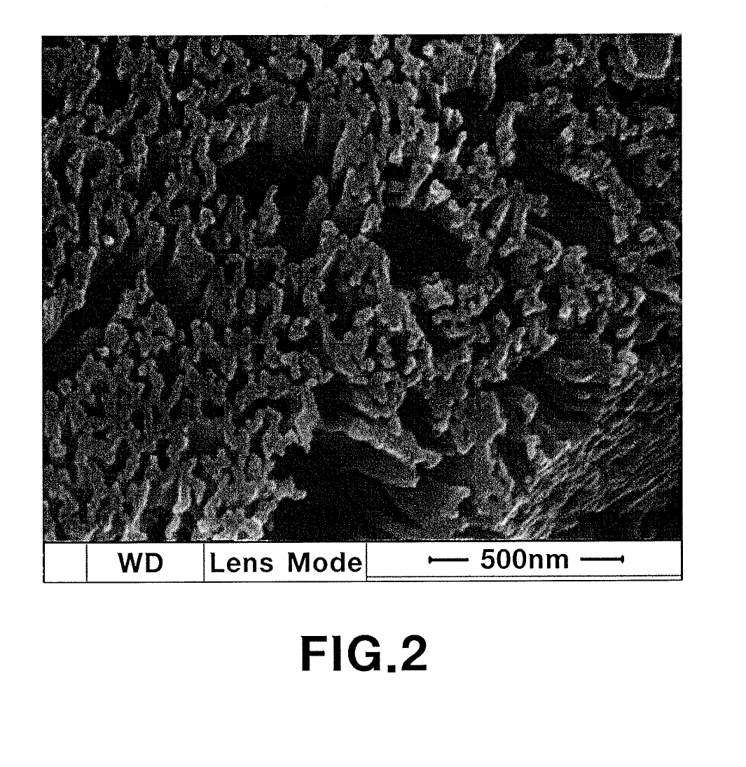

6.14 g of silver nitrate (AgNO₃) and 87 ml of hydrofluoric acid (HF, 48-52%) are added to 900 ml of distilled water and stirred for about 10 minutes. After stirring, the silicon thin film electrode is dipped into the distilled water and the distilled water is stirred for about 1 hour. The electrode obtained after reaction is washed with distilled water several times to remove non-reacting impurities. Last, the electrode is dipped in a 30% nitric acid solution for about 30 minutes to completely remove silver electrodeposited on the surface, and is then dried for about four hours at 80° C. The surface shape of the manufactured bundle type silicon nano-rod electrode is shown in FIG. 2. As shown in FIG. 2, the surface-treated bundle type silicon nano-rod surface is in the shape of a column (cylindrical) structure, and a diameter of each formed column is about 50-100 nm.

### (4) Manufacturing Example 4

### Manufacturing of Pouch Cell

For a cathode, 85 wt % of an activated carbon (YP-50F, Kuraray), 5 wt % of DB-100, and 10 wt % of PVDF are mixed in a homoginizer at 5000 rpm for about 15 minutes. For the anode, 82.5 wt % of Li₁₄Ti₁₅O₁₂ (LTO, ALDRICH), 10 wt % of DB-100, and 7.5 wt % of PVDF are mixed in the homoginizer at 5000 rpm for about 15 minutes, and the mixed slurry is casted in the Al foil (20 μm, Sama Al) by a 200 μm Dr. Blade and dried in an 80° C. oven for 2 hours or more. The dried foil is molded to a size of 2×2 cm and a temperature of a roll press is adjusted to 110-120° C., after which the cathode is pressed to a thickness of 80 μm and the anode is pressed to a thickness of 60 μm. In the vacuum oven of 80° C., drying is performed for 4 hours, and then by using a 1M LiPF₆ EC/EMC/DMC (1:1:1 v/v) electrolyte and a 1M LiPF₆ EC/EMC/DMC (1:1:1 v/v) electrolyte, a pouch cell is manufactured.

### (5) Manufacturing Example 5

### Manufacturing of Lithium-Alloyed Anode Activated Material

The activated materials forming the cathode and the anode manufactured in Manufacturing Examples 1 and 2 do not contain lithium in their structures, such that the anode activated material is alloyed (or doped) with lithium, thus allowing flow of electric charge through movement of lithium ions.

For alloying, the manufactured anode is used as a working electrode, and a lithium foil is used for a counter electrode and a reference electrode, thus manufacturing a half cell.

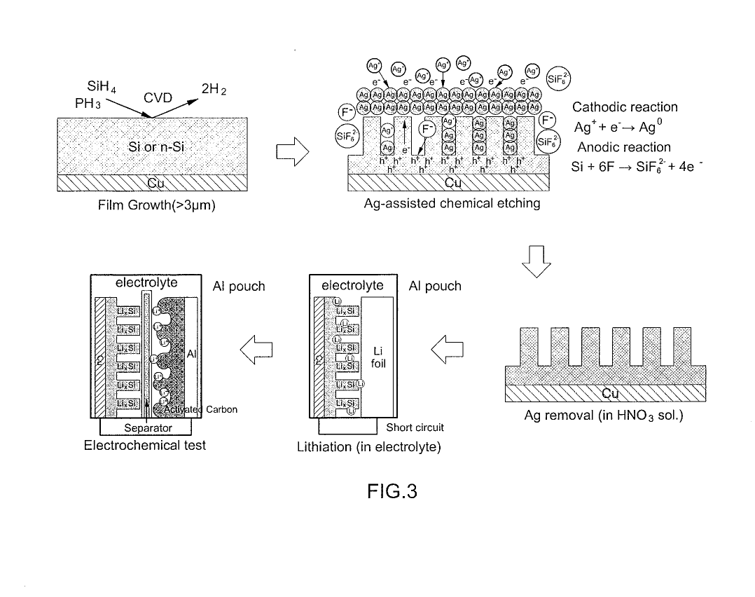

To physically prevent contact between the cathode and the anode and allow movement of lithium ions in the electrolyte, a polypropylene separator is used. Thereafter, a mixed electrolyte (volume ratio of 1:1:1) of ethylene carbonate, dietyle carbonate, and dimethyl carbonate, which is packed using an Al pouch and in which 1 mol of lithium hexafluorophosphate (LiPF₆) is dissolved, is injected to manufacture a lithium ion asymmetric secondary battery. All processes of asymmetric secondary battery assembly are performed in a dry room whose relative humidity is maintained below 3% to prevent introduction of moisture. More specifically, for a silicon-based electrode, the silicon electrode and a lithium electrode are assembled as a half-cell, lithium is inserted up to 0.001V with 0.2 C, is discharged, and then is inserted again. A manufacturing process for the lithium ion asymmetric secondary battery using a porous silicon electrode is shown in FIG. 3. However, in case of an LTO-based battery of Manufacturing Example 4, the lithium insertion process is not performed.

### (6) Embodiment 1

### Manufacturing of Lithium Ion Asymmetric Secondary Battery According to Manufacturing Examples 1, 2, and 3 and Charge/Discharge Test Thereof

The lithium ion asymmetric secondary batteries are manufactured according to Manufacturing Examples 1, 2, and 3 and their performances are evaluated through a charge/discharge test. The lithium ion asymmetric secondary batteries manufactured according to Manufacturing Examples 1, 2, and 3 are subject to a charge/discharge test in a constant-current condition of 8 mA in a potential range of 2.3-3.8V by using a Won A Tech WBCS3000 battery cycler. The lithium ion capacitor manufactured according to Manufacturing Example 4 is subject to a charge/discharge test in a constant-current condition of 8 mA in a potential range of 1.5-3.5V.

TABLE 1

| | Capacitance | Energy Density | Potential |
|---|---|---|---|
| System Configuration | (F/g)^{b} | (Wh/kg)^{c} | Period (V) |
| AC^{d}/Li4Ti5O12 | 96.204 | 46.760939 | 1.5 ~ 3.0 |
| AC/LiSi (0.5)^{a} | 1644.625 | 73.79984 | 2.3 ~ 3.8 |
| AC/LiSi^{e} (1.5) | 513.669 | 65.083469 | 2.3 ~ 3.8 |
| AC/LiSi (3) | 335.827 | 78.79523 | 2.3 ~ 3.8 |
| AC/Li-nSi^{f} (0.5) | 1435.83 | 64.430508 | 2.3 ~ 3.8 |
| AC/Li-nSi (3) | 357.896 | 83.973289 | 2.3 ~ 3.8 |
| AC/Li-nSi (3) | 357.896 | 99.44205 | 2.3 ~ 4.5 |

^{a}Herein, a number in ( ) indicates a thickness of an electrode (unit: μm)
^{b}For an anode
^{c}Based on a total weight of an activated material
^{d}AC: Activated carbon
^{e}Si: Porous silicon
^{f}nSi: Phosphorus-doped porous silicon

As can be seen from Table 1, an electrode capacity corresponding to Manufacturing Example 4 is mostly about 100 F/g (for the anode), whereas a bundle type silicon nano-rod electrode or a phosphorus-doped bundle type silicon nano-rod electrode manufactured according to Manufacturing Examples 1, 2, and 3 have energy density which is about 2 times that of an LTO-based electrode manufactured according to Manufacturing Example 4. For a silicon electrode, capacitance varies with thickness, in which as the thickness increases, the capacitance value decreases. This means that in charge/discharge, reaction between silicon and lithium is mainly surface reaction. In addition, a silicon-based bundle type nano-rod electrode may have a maximum voltage operation range of up to 4.5V, and in this case, energy density reaches about 100 Wh/kg.

### (7) Embodiment 2

### Manufacturing of Lithium Ion Asymmetric Secondary Batteries According to Manufacturing Examples 1, 2, 3, and 5 and Charge/Discharge Test Thereof

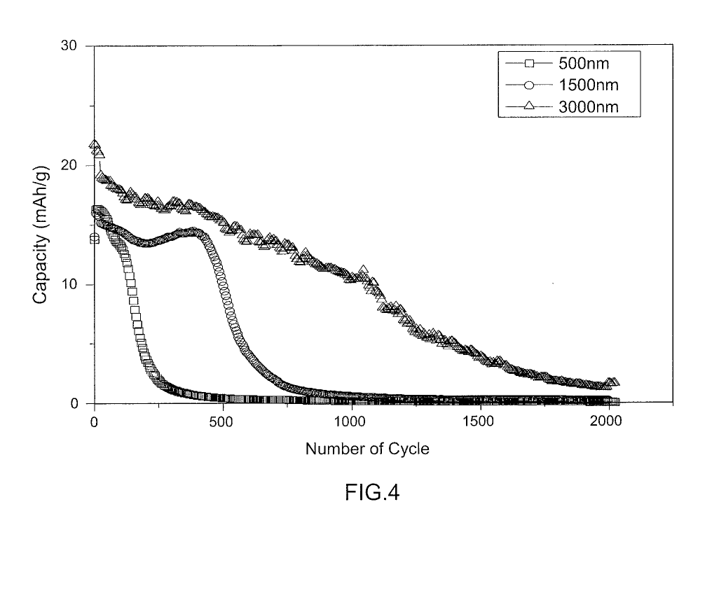

Lithium ion asymmetric secondary batteries are manufactured according to Manufacturing Examples 1, 2, 3, and 5 in that order. In particular, in Manufacturing Example 1, a non-phosphorus-doped silicon electrode manufactured using chemical deposition is manufactured with different thicknesses of 500 nm, 1500 nm, and 3000 nm to evaluate their performances through a charge/discharge test. An area of the electrode is constant as 2×2 cm². The lithium ion asymmetric secondary batteries manufactured according to Manufacturing Examples 1, 2, and 3 are subject to a charge/discharge test in a constant-current condition of 8 mA in a potential range of 2.3-3.8V by using a Won A Tech WBCS3000 battery cycler. As shown in FIG. 4, the lifespan of the electrode increases as the thickness increases, although not exactly proportionally to the thickness. It is thought that this is because as silicon's volume is expanded and contracted by four times due to alloy reaction with lithium, an electrode activated material is desorbed from the current collector.

### (8) Manufacturing Example 3

### Manufacturing of Phosphorus-Doped Bundle Type Silicon Nano-Rod Electrode and Non-Phosphorus-Doped Bundle Type Silicon Nano-Rod Electrode

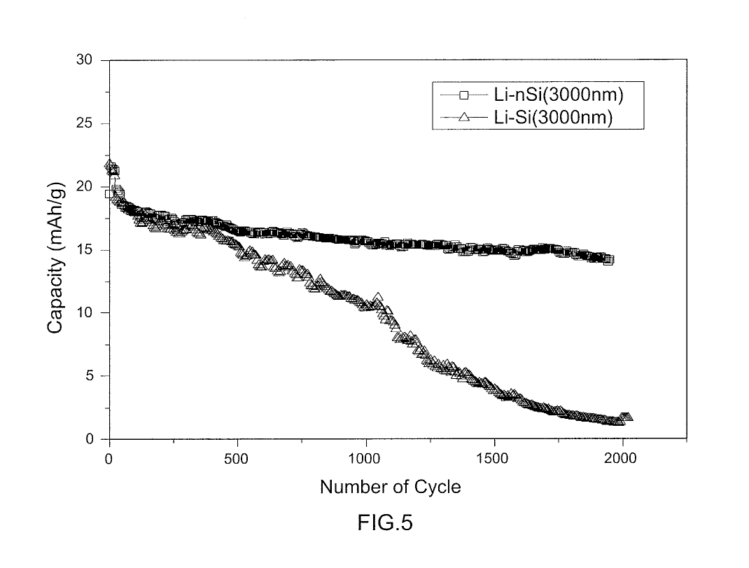

To investigate electrochemical characteristics of a phosphorus-doped silicon electrode and a non-phosphorus-doped bundle type silicon nano-rod electrode, the lithium ion asymmetric secondary batteries are manufactured like in Manufacturing Examples 1 and 2. In particular, the silicon electrode manufactured by chemical deposition in Manufacturing Example 1 is manufactured to a thickness of 3000 nm and performance thereof is evaluated by a charge/discharge test. An area of the electrode is constant as 2×2 cm². Herein, in phosphorus-doped bundle type silicon nano-rod, a weight percent of doped phosphorus is about 1%. In a comparison test, an electrochemical condition is the same as Embodiment 2. A comparative picture is shown in FIG. 5, and as can be seen, a phosphorus-doped porous silicon material shows higher electrode stability. This may originate from improvement of cycle characteristics due to reduction of ohmic resistance of the electrode resulting from low resistance of the phosphorus-doped silicon.

To sum up, the present invention may have the following characteristics and advantages:

(i) the asymmetric lithium ion secondary battery according to the present invention uses porous silicon alloyed with lithium ions as an anode and an interface having a large contact area with an electrolyte allows a large delivery path of the electrode, thus increasing the amount of lithium ions passing per unit time and ultimately allowing high rate. In addition, due to the nature of a material structure which relaxes shearing stress generated in alloying of a silicon material with lithium, stress caused by volume change occurring in reaction with lithium is alleviated, thereby improving the stability of the electrode;

(ii) the porous silicon electrode alloyed with lithium ions according to the present invention has superior energy storage density per unit volume and excellent cycle performance even in a high-voltage condition, such that the lithium ion asymmetric secondary battery including the bundle type silicon nano-rod electrode simultaneously satisfies high-capacity and high-power features; and

(iii) through the asymmetric hybrid lithium ion secondary battery according to the present invention, lightweightness and size increase of a mobile device using the battery as a power source can be realized.

While the embodiment of the present invention has been described in detail, the scope of the present invention is not limited thereto, and various changes and modifications made by those of ordinary skill in the art using the basic concept of the present invention defined in the appended claims are also included in the scope of the present invention.

What is claimed is:

1. An asymmetric hybrid lithium ion battery comprising a cathode which is an activated carbon and an anode which is silicon alloyed with lithium.

2. The asymmetric hybrid lithium ion battery of claim 1, wherein the silicon alloyed with lithium is bundle type silicon nano-rod or phosphorus-doped bundle type silicon nano-rod having a column structure.

3. The asymmetric hybrid lithium ion battery of claim 2, wherein the silicon having the column structure has an equivalent diameter of about 50-100 nm and a height thereof is about 500-5000 nm.

4. The asymmetric hybrid lithium ion battery of claim 2, wherein the phosphorus-doped silicon is doped with phosphorus using electron cyclotron resonance and chemical vapor deposition.

5. The asymmetric hybrid lithium ion battery of claim 2, wherein the amount of doped phosphorus in the phosphorus-doped silicon is about 0.1-10 wt % relative to a total doped-silicon electrode.

6. The asymmetric hybrid lithium ion battery of claim 2, wherein the porous silicon forms porosity via electroless etching.
